(19) United States
(12) Patent Application Publication
(10) Pub. No.: US 2008/0249728 A1
(43) Pub. Date: Oct. 9, 2008

(54) METHOD FOR DETECTING DEFECTS ON THE BACK SIDE OF A SEMICONDUCTOR WAFER

(75) Inventors: Detlef Michelsson, Wetzlar-Naunheim (DE); Daniel Skiera, Langgoens (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Weilburg (DE)

(21) Appl. No.: 12/056,734

(22) Filed: Mar. 27, 2008

(30) Foreign Application Priority Data
Apr. 5, 2007 (DE) 10 2007 016 922.3

(51) Int. Cl. G06F 19/00

(52) U.S. Cl. 702/82

(57) ABSTRACT

The invention relates to a method for detecting defects on the back side of a semiconductor wafer. The brightness distribution of the color values is essentially a normal distribution. An average value and surroundings can be defined using the determined normal distribution, which are criteria for the occurrence of a defect.

### RELATED APPLICATIONS

This application claims priority to German Patent Application No. 10 2007 016 922.3, filed on Apr. 05, 2007, which is incorporated herein by reference in its entirety.

### FIELD OF THE INVENTION

The present invention relates to a method for detecting defects on the back side of a semiconductor wafer.

### BACKGROUND OF THE INVENTION

German Patent Application DE 103 07 454 discloses a method and a software for optically inspecting a semiconductor substrate. The method disclosed here is used to inspect a wafer or to detect defects on a wafer, respectively. The structures for the semiconductor components are deposited on the surface to be inspected. A thin layer of photoresist is applied to the semiconductor substrate to structure the structures. An image is recorded of the front side of the semiconductor substrate, composed of a plurality of pixels each having associated color values and intensities. A brightness distribution of pixels having the same color coordinate values is calculated from the color values in a color space formed by an intensity and by color coordinates. A corresponding brightness distribution can be calculated from a second semiconductor substrate. By comparing the two brightness distributions defects can be identified from the differences. The DIE structure applied on the front side of the wafer must be taken into account, however, when images are recorded. The image fields to be imaged should be chosen such that the image content is always the same, regardless of whether a first, second or further wafer is imaged.

### SUMMARY OF THE INVENTION

It is therefore an object of the present invention to provide a method for detecting defects on the unstructured back side of the wafer. Not only global defects, affecting the whole surface of the back side of the wafer, but also surface defects low in contrast, and small defects with higher contrast should be detected.

The present object is solved by a method for detecting defects on the surface of the back side of the semiconductor wafer, wherein the method involves first, recording an image of an area of the surface of the back side of the semiconductor wafer with a camera using a freely selectable window, wherein the image consists of a plurality of pixels, wherein the at least three associated intensities have different wavelengths, which are referred to as color values. A frequency distribution is calculated from the color values, whereby the resulting frequency distribution is a normal distribution. The normal distribution serves to determine the average value and spread of the normal distribution. Additionally, surroundings of the average value are defined. The color values of the frequency distribution are compared to establish whether the color values are within the defined surroundings. Should the color value lie outside the defined surroundings, an error is detected.

It is further advantageous if color values are recorded in an ultraviolet, visible or infrared wavelength range. Moreover, imaging of the back side of the wafer can be carried out using light of various polarizations or light with a varying angle of incidence or with infrared light in the transmitted-light mode or using N-channel spectrometry.

According to a further embodiment, the inventive method can be implemented with the aid of software or a computer program. The computer program comprises program code means to enable execution of the inventive method steps. The computer program is run on a suitable computer or any other data processing means, able to control the calculation and comparison means. Preferably, the software or computer program comprises program code means stored on a machine-readable data storage medium.

The calculated color values can be transformed into a different color space for evaluation of the data. Further advantageous embodiments of the invention are defined in the dependent claims.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a schematic representation of the spatial arrangement of a substrate supply module and a workstation, in which the inventive procedure is carried out;

FIG. 2 shows a histogram calculated from the imaged data of the back side of the wafer, wherein the histogram of the unstructured back side of the wafer essentially has the form of a normal distribution;

FIG. 3 shows the normal distribution of FIG. 2, wherein the average value and differing scatter areas are depicted; and

FIG. 4 shows a schematic block diagram of the inventive method.

### DETAILED DESCRIPTION OF THE PREFERRED EMBODIMENTS

Identical reference numerals indicate identical or essentially equivalently effective elements or functional groups.

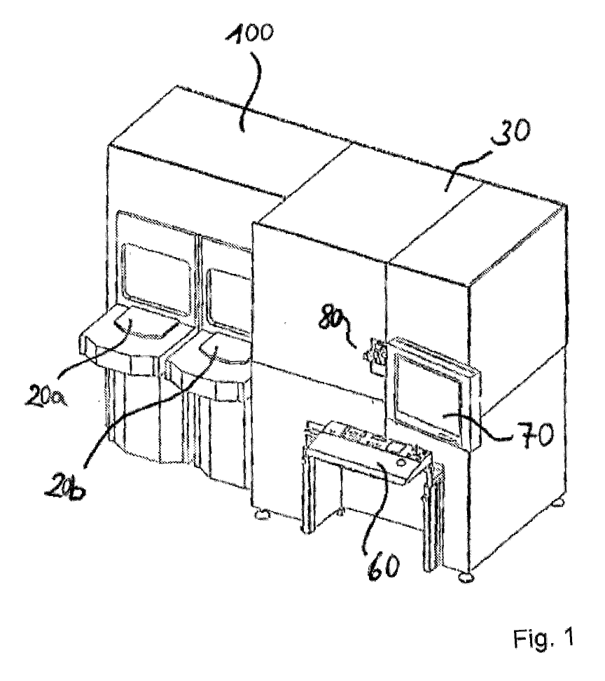

FIG. 1 shows in an exemplary manner a spatial representation of an inspection apparatus for the wafer, in which the inventive method is implemented. The inspection apparatus comprises a substrate supply module 100 and at least one workstation 30. Further, the inspection apparatus is provided with a display 70 to enable the user to monitor inputs made via the input device 60. Moreover, images of defects on the back side of the wafer recorded by the workstation can be visually displayed to the user on display 70. In addition to this, the evaluation of recorded images from the back side of the wafer is also displayed on display 70. The embodiment illustrated herein also provides for the wafer to be directly examined using a microscope via a microscope aperture 80. The substrate supply module 100 comprises a plurality of load ports on its front side 20a, 20b, used to supply the wafers to the inspection apparatus 100. The user can use display 70 to set parameters required for evaluation of the image data from the back side of the wafer, to enable detection of defects thereon on the basis of the set parameters.

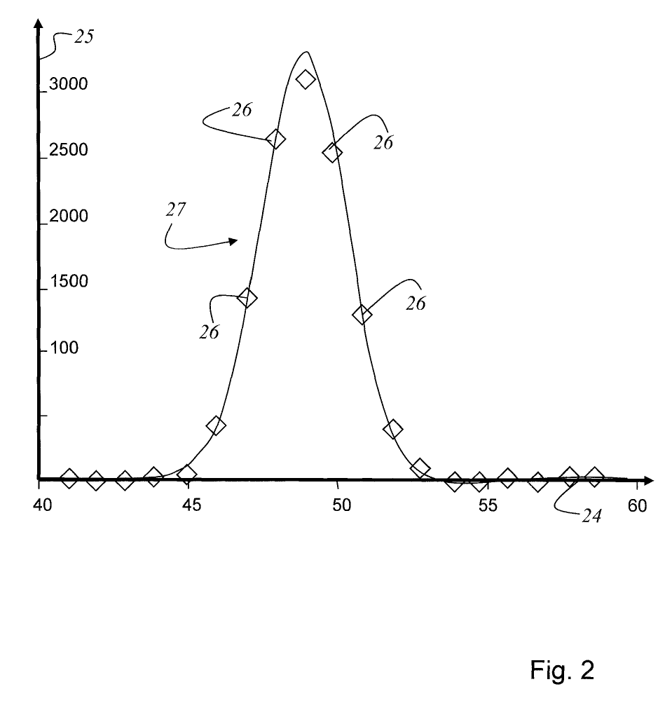

FIG. 2 shows a frequency distribution 22 of the color values, calculated from an image of the back side of the wafer. Since the back side of the wafer has no repetitive structures, as is expected on the front side of the wafer, the window within which the color values are formed to a histogram can be freely selected. Depending on the size of the window selected, e.g. selection of a large window, high sensitivity for the detection of large-area defects results. Subsequently, selection of a large window leads to low noise sensitivity with respect to pixel noise of the individual pixels of the detector used to record image data. If, on the other hand, a small window is selected, local resolution for defects with low contrast is higher. However, small measuring windows are more sensitive to pixel noise.

According to a particular embodiment, an RGB camera is used to detect image data from the back side of the wafer. Additional channels can, however, also be added. Conceivable here is the use of infrared light, UV light, light of differing polarizations, light with different incident angles, infrared in the transmitted-light mode, N-channel locally resolved spectrometry etc. A limitation to two channels is also conceivable. The RGB values (color values) of the pixels of the currently utilized window detected by the camera are combined in a frequency distribution. Herein, it has proven useful to select two of the three color values for the frequency distribution. It is further conceivable, to transform the measured color values into a different color space before the frequency distribution is created. Transformation into a different color space should not, however, be construed as limiting to the invention. According to a particular embodiment of the present invention the YUV color space is selected here. Any other transformations are, however, also conceivable. In the embodiment shown here, only two parameters are selected and in association therewith, the frequency of incidence of the individual value combinations or color values within the selected measuring window is determined. A two-dimensional histogram is thus created. Since the back side of the wafer is unstructured, a distribution as illustrated in FIG. 2 should result (only one dimension is depicted in FIG. 2). It is possible to conceive the back side of the wafer as a homogenous surface. The signal noise of the individual pixels of the camera can be regarded as distributed normally in a first approximation. This histogram can thus be interpreted as a normal distribution of measured values. In FIG. 2, the abscissa 24 shows the number of pixels having a specific color value. The ordinate 25 is the color value in freely selected units. The measured values 26 are shown as diamonds. The measured values 26 can be approximated by a curve (function) 27, which as described above, corresponds to a normal distribution since the back side of the wafer is conceived to be a homogenous surface.

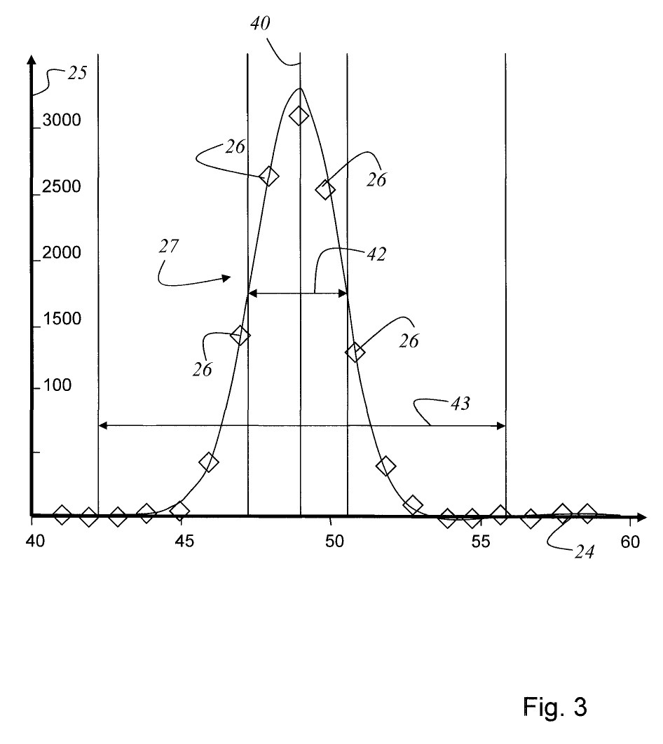

FIG. 3 shows the normal distribution of measured values as illustrated in FIG. 2, with the average value 40 indicated in the image. In addition to this, a user can further define first surroundings 42 or second surroundings 43 about average value 40. The spread of this measured value can be evaluated on the basis of average value 40. To avoid corruption of the spread as a result of errors, a process of elimination of freak values is carried out. As already described with reference to FIG. 1, the user can choose the surroundings best suited to the measuring conditions. Once the size of the surroundings or the spread is defined, all combinations of values or color values outside of the area surrounding average value 40, or modal value, can be understood as errors. The size of the surroundings is determined by the spread and one freely selectable factor defined by the user.

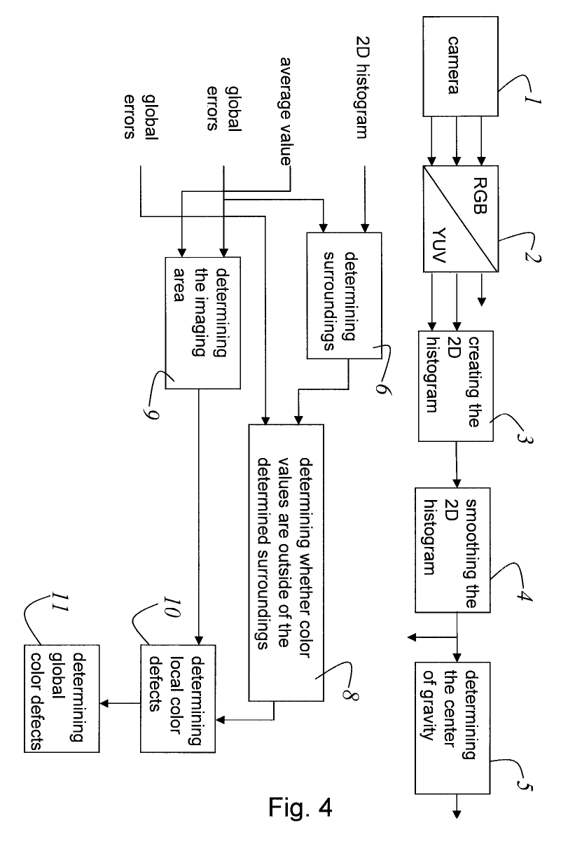

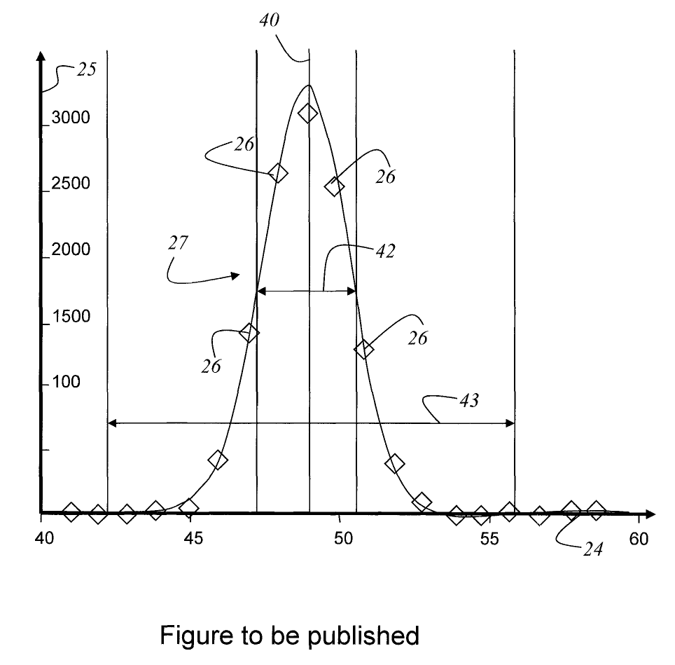

FIG. 4 shows a schematic representation of the method flow for the inspection of defects on the back side of a wafer. As already described, a color-sensitive CCD camera 1, with a freely adjustable window, is used to image the back side of the wafer. The image information comprises a plurality of pixels with associated color values and intensities. Each pixel of the color image is provided with intensity values by camera 1. The value of each individual channel is dependent on the spectral sensitivity of the individual sensor and the incident light. In the embodiment described herein, the image information recorded by the camera is passed to an image processing means 2, which transforms the RGB components of the image information into the YUV color space. Transformation is simply another way of displaying the measured values. The YUV color space serves as the basis for color coding in television standards applicable in Europe, and is comprised, as is well known, of the following RGB components of image information:

Y=0.299R+0.587G+0.114B

U=−147R−0.289G+0.437B=0.493 (B−Y)

V=0.615R−0.515G−0.100B=0.877 (R−Y)

The Y component represents luminance. The YUV color space is thus formed by the intensity and color coordinates U, V. As already mentioned above in the description with reference to FIG. 2 and FIG. 3, the Y component is not considered in the processing of the image information, as indicated in FIG. 4 by a dashed arrow between blocks 2 and 3. The remaining U and V color values thus form a two-dimensional color space. Using calculation means 3, the frequency of incidence of a pixel with equal U and V values for the defined image area is summed up. The frequency distribution (histogram) depicted in FIG. 2 and FIG. 3 is thus calculated in the two-dimensional color space. In a further method step, indicated with reference numeral 4, the two-dimensional histogram is smoothed. This smoothing process is for the elimination of freak values. As already described with reference to FIG. 2, the histogram formed using image data from the back side of the wafer, can be regarded as a normal distribution. In a further step, indicated with reference numeral 5, the center of gravity or center point of the histogram is determined.

The further processing steps of the inventive method are illustrated in the lower section of FIG. 4. In the comparison step in the inventive method, which can optionally be executed in block 7 or block 9, a check is first made as to whether or not a color value lies outside of defined surroundings. The second frequency distribution can, for example, be derived from a different image area of the same wafer, or from the same image area of a different wafer. If the position of the center point of the frequency distribution is not identical with, for example, a reference frequency distribution, this results from a color shift of the light reflected by the back side of the semiconductor substrate. This deviation alone already indicates a defect on the back side of the wafer. In block 9 it is determined how the size of the imaging area will be defined. In dependence on the imaging area used for calculation of the frequency distribution, it is possible to carry out in a subsequent block 10 determination of local color defects or in a subsequent block 11 determination of global color defects. Local color defects caused, for example, due to small defects or particles, can, for example, be detected by a comparison of the frequency distributions of two local surface areas of one and the same wafer, or by the occurrence of a signal outside the surroundings of the normal distribution. Global defects, on the other hand, lead to a systematic color shift of the normal distribution of signals, imaged from the back side of the wafer.

Additionally, the surroundings of the center point for the back side of the semiconductor substrate to be inspected, is calculated by block 6. In the case of a local color shift, for example, further signals can occur outside the defined surroundings of the normal distribution of the back side of the wafer to be inspected, which would once again indicate an error.

As an alternative, two normal distributions can be subtracted from one another in block 8. Additionally, the remaining difference can be amplified by multiplication with a predetermined factor. In this way, even small differences in the normal distribution can be detected.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for detecting defects on a surface of a back side of a semiconductor wafer, comprises the following steps:
recording an image of an area of the surface of the back side of the semiconductor wafer using a freely selectable window by means of a camera, whereby the recorded image comprises a plurality of pixels, wherein at least three associated intensities have different wavelengths, each referred to as color values;
calculating a frequency distribution using two of the three recorded color values, wherein the frequency distribution is a normal distribution;
calculating an average value and spread of the normal distribution and definition of surroundings of the average value;
comparing the color values of the frequency distribution to establish whether the color values lie within the defined surroundings; and
indicating an error, if the color value lies outside the defined surroundings.

2. The method according to claim 1, wherein the color values are recorded in the ultraviolet, visible or infrared wavelength range or with light of different polarization or with a different incident angle or in IR transmitted light or with n-channel spectrometry.

3. The method according to claim 1, wherein the color values are recorded with an RGB camera.

4. The method according to claim 1, wherein the recorded color values of the image are transformed into a different color space.

5. The method according to claim 4, wherein the different color space is the YUV space.

6. The method according to claim 5, wherein the color value Y corresponds to the light intensity or luminance of the pixels and wherein Y is not considered in the representation of the frequency distribution.

7. The method according to claim 1, wherein freak values are eliminated from the measured values in the brightness distribution of the transformed color values.

8. The method according to claim 1, wherein the sensitivity for the detection of defects on back side of a semiconductor wafer is defined via the selection of the size of the window.

9. The method according to claim 8, wherein the selection of a large window produces high sensitivity for the detection of large surface defects with low noise sensitivity.

10. The method according to claim 8, wherein selection of a small window produces high local resolution for defects with low contrast.

11. The method according to claim 1, wherein the size of the window can be defined using a display screen and/or a keyboard.

12. A software, comprising program code means, for executing all steps, when the software or the computer program is run on a computer or on data processing means, the steps comprise:
recording an image of an area of the surface of the back side of the semiconductor wafer using a freely selectable window by means of a camera, whereby the recorded image comprises a plurality of pixels, wherein at least three associated intensities have different wavelengths, each referred to as color values;
calculating a frequency distribution using two of the three recorded color values, wherein the frequency distribution is a normal distribution;
calculating an average value and spread of the normal distribution and definition of surroundings of the average value;
comparing the color values of the frequency distribution to establish whether the color values lie within the defined surroundings; and
indicating an error, if the color value lies outside the defined surroundings.

13. The software, including program code means, according to claim 12, which are stored on a machine-readable data storage medium.
